(19) United States
(12) Patent Application Publication
(10) Pub. No.: US 2003/0095215 A1
(43) Pub. Date: May 22, 2003

(54) Foldable pedestal of LCD monitor

(75) Inventor: Shih-Chun Huang, Taipei (TW)

Correspondence Address: LOWE HAUPTMAN GOPSTEIN, GILMAN & BERNER, LLP, 1700 Diagonal Road, Suite 310, Alexandria, VA, 22314, US

(73) Assignee: QUANTA COMPUTER INC.

(21) Appl. No.: 10/165,949

(22) Filed: Jun. 11, 2002

(30) Foreign Application Priority Data
Nov. 20, 2001 (TW) 90220000

(51) Int. Cl. G02F 1/1333

(52) U.S. Cl. 349/58

(57) ABSTRACT

A foldable pedestal is mounted to a LCD panel of a LCD monitor. The foldable pedestal comprises a support base on which a rotation limiter is slidably mounted. A rotary plate, including a connecting area where the LCD panel is fixedly attached, is pivotally mounted to the support base over the rotation limiter. Blocking elements are fastened to the rotary plate. When the rotation limiter is in a first position, the rotary plate is in an unfolding position, and is prevented from substantial rotation due to an abutment of the blocking element against the rotation limiter. When the rotation limiter slidably moves to a second position, a clearance is created to allow the passage of the blocking elements so that the rotary plate is allowed to rotate to a folding position.

### BACKGROUND OF THE INVENTION

1. Field of the Invention

The invention relates to liquid crystal display (LCD) monitors. More particularly, the invention relates to a foldable pedestal for LCD monitors.

2. Description of the Related Art

In addition to high-speed and high-performance, consumer demands emphasize on lighter, thinner, and smaller electronic products. Liquid crystal display (LCD) monitors have emerged as the mainstream of the next generation of display equipment because they provide the advantages of reduced size, lightweight, low power consumption, and no radiation.

The thickness of LCD monitors is far thinner than traditional cathode-ray tube (CRT) monitors. In order to erect the LCD monitor on a table, there is a need of a pedestal which has a substantially large (larger than the thickness of the LCD panel) base to ensure a stable standing of the LCD monitor. Such a large pedestal occupies an excessive packing volume and thus negatively increases the packaging cost. Moreover, even if the LCD monitor is lightweight, the user still has to hold the LCD monitor with both hands because no handle is provided thereon. The traditional LCD monitor therefore is not ergonomic and convenient.

### SUMMARY OF THE INVENTION

An aspect of the invention is therefore to provide a foldable pedestal for LCD monitor that can overcome the above disadvantages by allowing a compact arrangement of the LCD monitor to reduce the packing volume and facilitate hand carrying of the LCD monitor.

To accomplish the foregoing and other objectives, the invention provides a foldable pedestal for a LCD monitor having a LCD panel. The foldable pedestal comprises a support base adequately shaped to enable a stable standing of the LCD monitor. A rotation limiter is slidably mounted to the support base in a manner to be able to slide between a first position and a second position. The rotation limiter is connected to the support base via a resilient spring. A rotary plate is pivotally mounted to the support base over the rotation limiter. The rotary plate includes a connecting area where the LCD panel is fixedly attached. Blocking elements, respectively provided with blocking extensions, are fastened to the rotary plate over the rotation limiter. The blocking elements and the blocking extensions are arranged in such a manner that a slight rotation of the rotary plate causes an abutment of the blocking extensions against the rotation limiter when the rotation limiter is in the first position. The rotary plate is thereby restricted to an unfolding position when the rotation limiter is in the first position. In the first position of the rotation limiter, the rotary plate is thus allowed a limited rotary deviation. By means of a sliding button fastened to the rotation limiter, a user can slidably move the rotation limiter to the second position to fold the rotary plate. The location of the rotation limiter in the second position creates clearances that allow the passage of the blocking extensions of the blocking elements driven in rotation by a rotation of the rotary plate to a folding position. The resilient spring is directed to drive the rotation limiter from the second position back to the first position once the rotary plate has reached its unfolded position by reverse rotation. A casing is further included to the support base. The contour of the casing is shaped in a manner to define a handle member to allow hand carrying. The pedestal is generally shaped in a manner to achieve a compact arrangement once the pedestal and the LCD panel are folded onto each other.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1A is a front view showing a LCD monitor provided with a foldable pedestal in unfolding configuration according to an embodiment of the invention;

FIG. 1B is a side view of FIG. 1A;

FIG. 2A is a front view showing a LCD monitor provided with a foldable pedestal in folding configuration according to an embodiment of the invention;

FIG. 2B is a side view of FIG. 2A;

FIG. 2C is a rear view of FIG. 2A;

FIG. 3 is an exploded view of a foldable pedestal of a LCD monitor according to an embodiment of the invention; and

FIG. 4A through FIG. 7E are various schematic views illustrating a folding operation of the foldable pedestal according to an embodiment of the invention.

### DESCRIPTION OF THE PREFERRED EMBODIMENTS

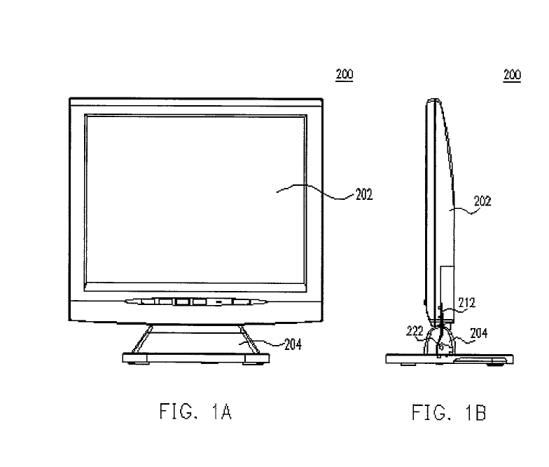

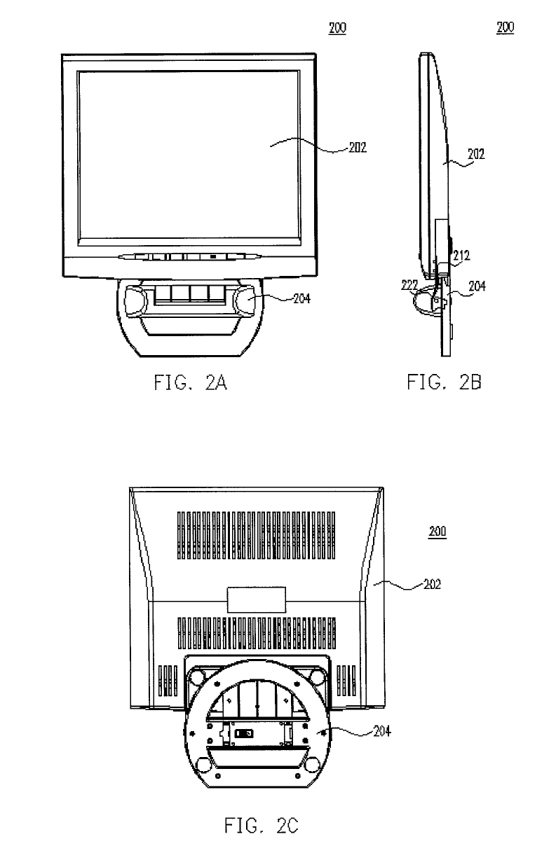

Referring now to FIG. 1A and FIG. 1B, FIG. 1A is a front view showing a LCD monitor provided with a foldable pedestal according to an embodiment of the invention, and FIG. 1B is a side view of FIG. 1A.

As shown in FIG. 1A, the LCD monitor 200 according to the invention includes a LCD panel 202 and a foldable pedestal 204. FIG. 1B is a side view of the LCD 200 illustrating the connection of the LCD panel 202 to the foldable pedestal 204 by means of a rotary plate 212. For clarity consideration, only some of the elements that achieve the connection of the foldable pedestal 204 to the LCD panel 202 are shown.

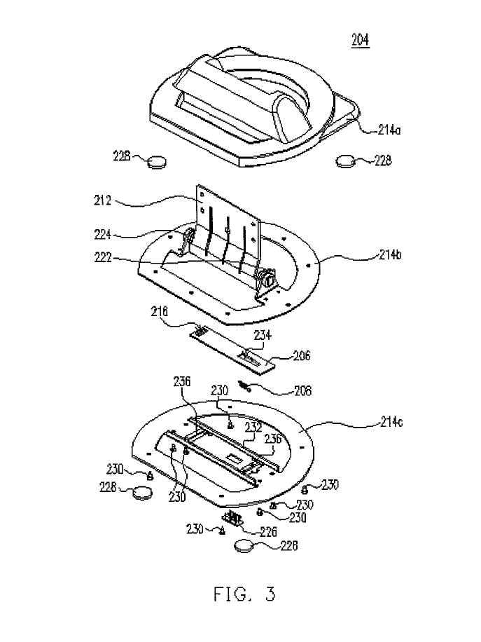

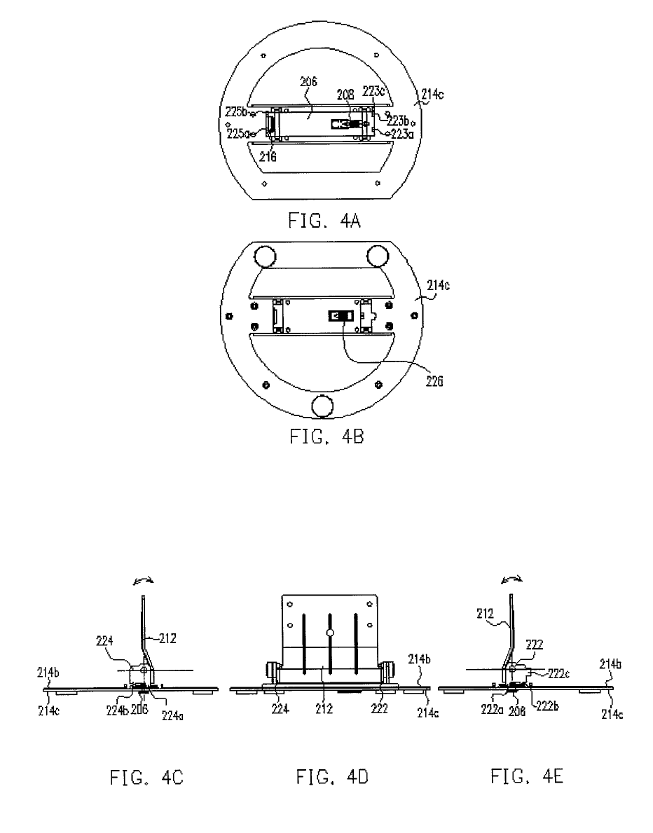

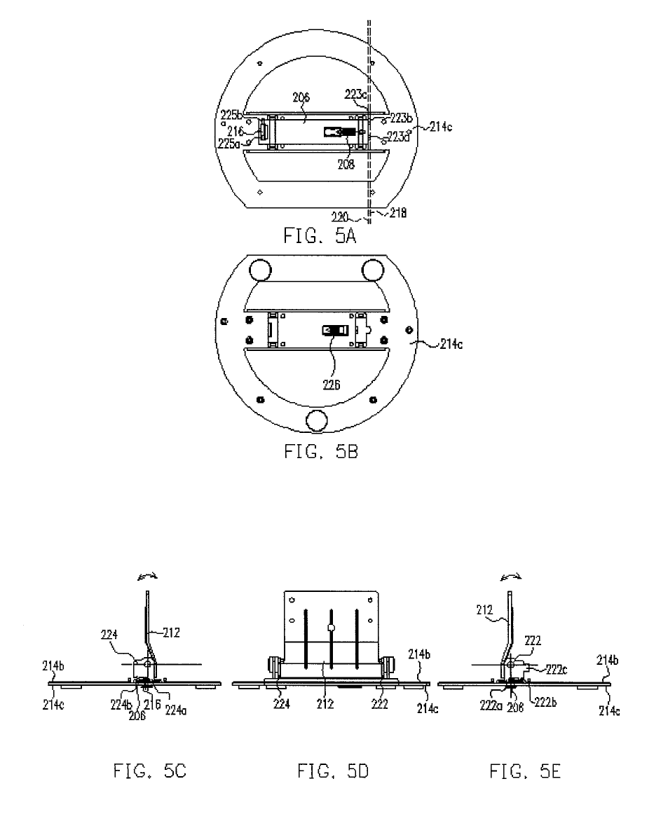

FIG. 2A through FIG. 2C schematically show the LCD 200 in a folding configuration according to an embodiment of the invention. FIG. 2A is a schematic front view showing the LCD monitor provided with the pedestal 204 of the invention in a folding configuration. FIG. 2B is a side view of FIG. 2A, and FIG. 2C is a rear view of FIG. 2A.

As shown in FIG. 2B, the foldable pedestal 204 is folded to the back of the LCD panel 202 in a manner not to substantially exceed the thickness of the LCD panel 202. As a result, packing and storage spaces are favorably reduced, packing thus is more economical and the transportation of the LCD monitor more convenient.

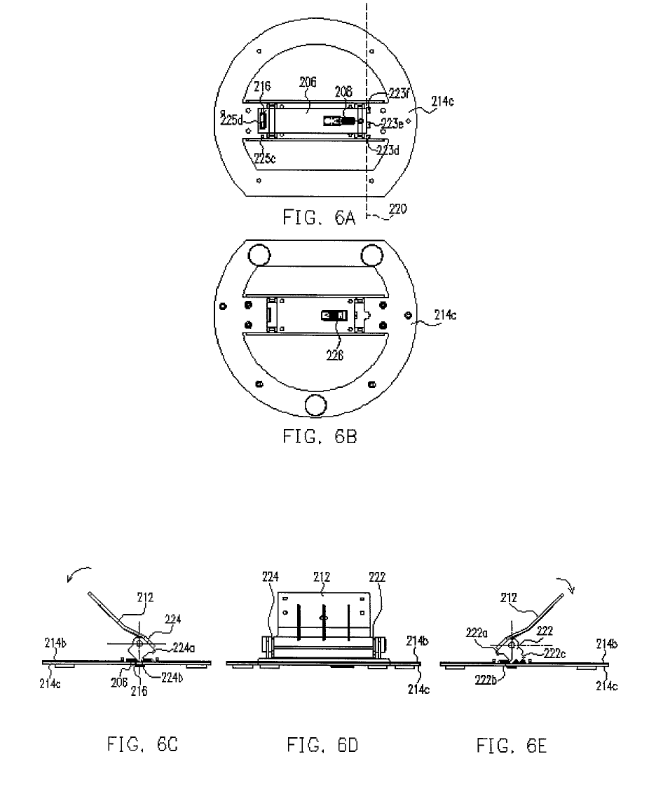

Referring to FIG. 3, an exploded view illustrates the foldable pedestal of a LCD monitor according to an embodiment of the invention.

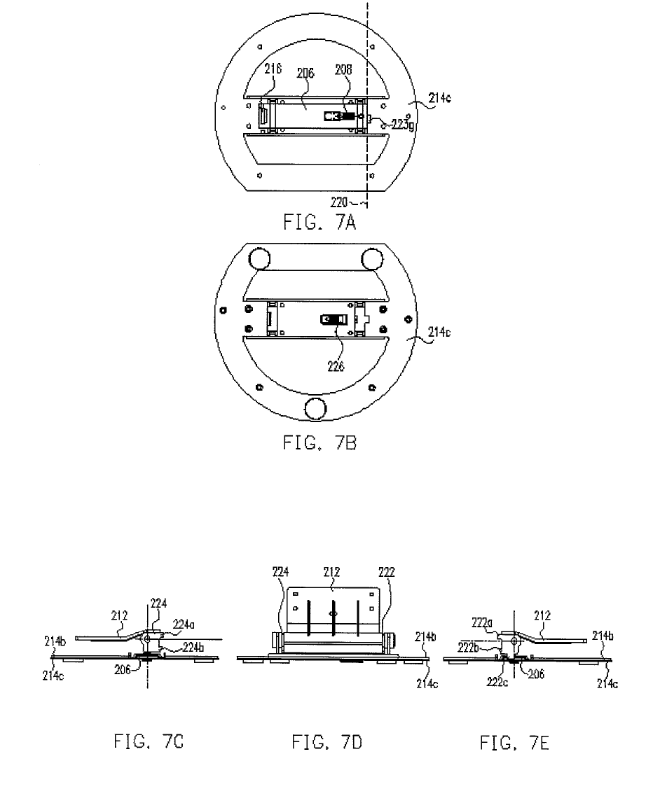

The foldable pedestal 204 according to an embodiment of the invention includes a support base that is comprised of support elements 214b, 214c assembled with each other. A sliding pathway 232 is defined on the support element 214c to receive a rotation limiter 206 therein. As illustrated in FIG. 3, the rotation limiter 206 may be, for example, a flat plate slidably received in the sliding pathway 232. Two retainer elements 236, placed across the sliding pathway 232, secure the mount of the rotation limiter 206 in the sliding pathway 232. The retainer elements 236 may be, for example, collar retainers formed by stamping. A slot 216 is defined through an end portion of the rotation limiter 206. As illustrated in FIG. 3 and FIG. 4A, the rotation limiter 206 of this embodiment may further include an opening 234 through which a slider button 226 is fixedly fastened to the rotation limiter 206. The slide of the rotation limiter 206 in the sliding pathway 232 is limited by means of a resilient member 208, for example a spring, that connects the rotation limiter 206 (for example by attaching to the slider button 226) to the support element 214c. For manual operation, the slider button 226 oppositely projects through an opening 234 of the support element 214c. The sliding range of the slider button 226 in the opening 234 of the support element 214c limits the slide of the rotation limiter 206 between a first position 218 and a second position 220 (see FIG. 5A, and description hereafter).

The support element 214b is fixedly assembled with the support element 214c over the rotation limiter 206 by means of fastening means 230 such as screws. The support element 214b defines a central cavity that exposes the underlying rotation limiter 206 and sliding pathway 232. Uplifted from the plane of the cavity, a rotary plate 212 is pivotally mounted to the support element 214b. The rotary plate 212 includes a connecting area for fixedly mounting the LCD panel 202.

Blocking elements 222, 224 are oppositely fastened to the rotary plate 212 and pivotally mounted with respect to the support element 214b. The blocking elements 222, 224 are mounted over and lengthwise aligned with the rotation limiter 206 and sliding pathway 232. This embodiment is implemented via a specific number of two blocking elements oppositely mounted to the rotary plate 212 to securely maintain the rotary plate 212, attached to the LCD panel 202, in the unfolding position when the rotation limiter 206 is in the first position 218. Side views of FIG. 4C and FIG. 4E illustrate a particular shape of the blocking elements 222, 224 according to an embodiment of the invention. As illustrated, the blocking element 222 comprises blocking extensions 222a, 222b, 222c that are arranged approximately according to a “F” shape. The blocking element 224 comprises blocking extensions 224a, 224b that are disposed approximately according to a “U” shape.

A casing 214a is fixedly assembled with the support elements 214b, 214c via fastening means 230. The casing 214a is preferably shaped in a manner to substantially cover the support elements 214b, 214c while leaving adequate passage for free rotation of the rotary plate 212. As illustrated in the drawings, the casing 214a and the support elements 214b, 214c are further adequately shaped to provide a stable standing of the pedestal and a compact arrangement of the pedestal in folding position. Skidproof pads 228 may be further fixed to the down side of the support element 214c to secure a stable standing of the pedestal 204.

Referring now to FIG. 4A through FIG. 7E, various schematic views illustrate a folding operation of the pedestal according to an embodiment of the invention. For the sake of clearer illustration, the casing 214a and the LCD panel 202 are omitted. In FIG. 4A through FIG. 7E, the drawings including a same numerical reference refer to a same configuration of the pedestal 204, and the drawings including the alphabetical references “A” and “B” more particularly illustrate the corresponding positions of the rotation limiter 206 and slider button 226. In the drawings including the alphabetical reference “A”, reference symbols 223 and 225 accompanied with different alphabetical characters illustrate perpendicular projections of the different blocking extensions 222a, 222b, 222c, 224a, 224b on a plane of the rotation limiter 206. In FIG. 4A where the rotary plate 212 is in an unfolding position, reference symbols 223a, 223b, 223c correspondingly show perpendicular projections of the blocking extensions 222a, 222b, 222c on the plane of the rotation limiter 206, and reference symbols 225a, 225b show perpendicular projections of the blocking extensions 224a, 224b on the plane of the rotation limiter 206.

In FIG. 4A through FIG. 4E, the rotary plate 212 is in an unfolding configuration, and the blocking elements 222, 224 are integrally positioned over the rotation limiter 206. The rotation limiter 206 is correspondingly in a first position 218 (see FIG. 5A), overlapping the first and second blocking elements 222, 224. As shown in FIG. 4A, the projections 223a and 223b of the blocking extensions 222a, 222b and the projections 225a, 225b of the blocking extensions 224a, 224b overlap the matter boundary of the rotation limiter 206. In the first position 218 of the rotation limiter 206, the rotary plate 212 thus is restricted to a limited inclination because the rotation of the blocking elements 222, 224 is blocked by the underlying rotation limiter 206 against which the blocking extensions 222a, 222b and the blocking extensions 224a, 224b abut when the rotary plate 212 is rotated.

Referring to FIG. 5A through FIG. 5E, by pushing the slider button 226, the user drives a lengthwise slide of the rotation limiter 206 to a second position 220, which stretches the resilient element 208. As shown in FIG. 5A, the corresponding projections 223a, 223b, 223c of the blocking extensions 222a, 222b, 222c now are located outside the boundary of the rotation limiter 206, whereas the projection 225a, 225b are aligned with the slot 26. The projection 225a of the blocking extension 224a is particularly within the boundary of the slot 216. The slide of the rotation limiter 206 thus creates a clearance that allows the rotary plate 212 to be folded by rotation, the blocking extensions 222a, 222b, 222c passing outside the rotation limiter 206 and the blocking extension 224a, 224b passing through the slot 216.

FIG. 6A through FIG. 6E illustrate an intermediary configuration in the folding operation where the rotary plate 212 is inclined approximately 45 degrees. In FIG. 6A, reference symbols 223d, 223e, 223f respectively illustrate the projections of the blocking extensions 222a, 222b, 222c on the plane of the rotation limiter 206, and reference symbols 225c, 225d illustrate the projections of the blocking extensions 224a, 224b. As shown in the side views of FIG. 6C and FIG. 6E, a portion of the blocking extension 224b passes through the slot 216 while portions of the blocking extensions 222b, 222c pass sidewise adjacently to one side of the rotation limiter 206. The rotation limiter 206 is against the blocking extensions 222c to prevent from sliding.

FIG. 7A through FIG. 7E illustrate a final configuration of the pedestal 204 that is completely folded. In FIG. 7A, reference symbol 223g illustrates the projection of the blocking extension 222c on the plane of the rotation limiter 206. As shown in FIG. 7C and FIG. 7E, once the rotary plate 212 is completely folded, the blocking element 224 is integrally positioned over the rotation limiter 206, whereas a portion of the blocking extension 222c is positioned sidewise adjacently to one side of the rotation limiter 206. By releasing the rotation limiter 206, the stretched resilient element 208 tends to drive the rotation limiter 206 from the second position 220 back to the first position 218. However, the position of the blocking extension 222c blocks the backward slide of the rotation limiter 206 that abuts against the blocking extension 222c. The rotation limiter 206 thus substantially remains in its second position 220, and the blocking extensions 222a, 222b, 222c are outside the boundary of the rotation limiter 206 and the blocking extensions 224a, 224b aligned with the slot 216. The rotary plate 212 thus can be unfolded by a reverse rotation. The reverse rotation is performed until the rotary plate 212 is completely unfolded, at the moment of which the blocking elements 222, 224 are integrally positioned over the rotation limiter 206. Under the resilient force exerted by the resilient element 208, the rotation limiter 206, free from any obstacles, thus is driven back to its first position 218, as shown in FIG. 4A through FIG. 4E.

As shown in FIG. 3, the casing 214a can be shaped in a specific manner to define a handle member so that once the pedestal 204 is completely folded (see FIG. 2A and FIG. 2C), the user can easily carry the LCD monitor with one hand gripping the handle member.

As described above, the invention thus provides a pedestal for LCD monitor that is foldable to facilitate the disposition and transportation of the LCD monitor. In an embodiment of the invention, the foldable pedestal comprises a rotary plate that is pivotally mounted to a support element, and a rotation limiter slidably mounted to the support element. The rotary plate is connected to a LCD panel of the LCD monitor. At least a blocking element is fixedly mounted to the rotary plate over the rotation limiter. In an unfolding position of the pedestal, the rotary plate stands upright over the support element, and the rotation limiter is in a first position that substantially blocks the rotation of the rotary plate by creating an abutment against the blocking element. To fold the pedestal, the user slidably move the rotation limiter to a second position that creates a clearance allowing the passage of the blocking element. The rotary plate then can be rotated to a fold position. Once the rotary plate has reached the folding position, the rotation limiter remains in the second position, so that the rotary plate can be reversely rotated to unfold the pedestal.

Once the pedestal is completely folded, the envelope of the LCD monitor is substantially reduced. Smaller packing volume is thus needed. The pedestal further includes a casing having a handle member to facilitate the transportation of the LCD monitor.

It will be apparent to those skilled in the art that various modifications and variations can be made to the structure of the present invention without departing from the scope or spirit of the invention. For example, those skilled in the art would have readily appreciated that the amount of blocking elements and the shapes of the blocking extensions may be variously modified to adequately perform the above functions of the invention with substantially the same results. In view of the foregoing, it is intended that the present invention cover modifications and variations of this invention provided they fall within the scope of the following claims and their equivalents.

What is claimed is:

1. A liquid crystal display (LCD) monitor comprising:
a LCD panel; and
a foldable pedestal fixedly mounted to the LCD panel, including:
a support base, adequately shaped to achieve a stable standing of the foldable pedestal;
a rotation limiter, slidably mounted to the support base in a manner to slide between a first position and a second position;
a rotary plate, pivotally mounted to the support base and including a connecting area where the LCD panel is fixedly mounted; and
at least a blocking element, fixedly mounted to the rotary plate, the blocking element being arranged in such a manner that the location of the rotation limiter in the first position substantially limits the rotation of the rotary plate by an abutment of the blocking element with the rotation limiter, the LCD panel being thereby restricted to an unfolding position, and the location of the rotation limiter in the second position creates a clearance that allows a passage of the blocking element driven in rotation by a rotation of the rotary plate to fold the LCD panel in a folding position.

2. The LCD monitor of claim 1, wherein the rotation limiter is connected to the support base via a resilient element that exerts a resilient force on the rotation limiter to drive the rotation limiter from the second position back to the first position.

3. The LCD monitor of claim 1, wherein the resilient element includes a spring.

4. The LCD monitor of claim 1, wherein a sliding button is fastened to the rotation limiter and oppositely exposed through an opening on a down side of the support base to allow a user to slidably move the rotation limiter from the first position to the second position.

5. The LCD monitor of claim 1, wherein the blocking element includes at least a blocking extension arranged in a manner to be close to a position of abutment against the rotation limiter when the rotation limiter is in the first position.

6. The LCD monitor of claim 5, wherein the blocking extension is shaped in a manner to sidewise lie adjacent to a side of the rotation limiter in the second position when the LCD panel is in the folding position so that the rotation limiter is prevented from coming back to the first position, thereby a reverse rotation of the rotary plate is enabled to unfold the LCD panel.

7. The LCD monitor of claim 5, wherein the blocking extension is arranged in a U-like shape.

8. The LCD monitor of claim 5, wherein the blocking extension is arranged in a F-like shape.

9. The LCD monitor of claim 1, wherein the support base further includes a casing having a contour shaped in a handle enabling a user to carry the foldable pedestal by gripping the handle once the foldable pedestal is folded.

10. A foldable pedestal for a liquid crystal display monitor (LCD) having a LCD panel, the foldable pedestal comprising:
a support base, adequately shaped to achieve a stable standing of the foldable pedestal;
a rotary plate, pivotally mounted to the support base over a surface of the support base and including a connecting area where the LCD panel is fixedly mounted;
at least a blocking element, fixedly mounted to the rotary plate over the surface of the support base and including at least a blocking extension; and
a rotation limiter, slidably mounted on the surface of the support base below the blocking element in a manner to be able to slide between a first position and a second position, wherein the location of the rotation limiter in the first position substantially limits a rotation of the rotary plate by abutment against the blocking extension so that the LCD panel is restricted to an unfolding position, while the location of the rotation limiter in the second position creates a clearance that allows the passage of the blocking extension driven in rotation by a rotation of the rotary plate to a folding position.

11. The foldable pedestal of claim 10, wherein the rotation limiter is connected to the support base by means of a spring element that exerts a resilient force on the rotation limiter when the rotation limiter is in the second position to drive the rotation limiter back to the first position.

12. The foldable pedestal of claim 10, wherein a sliding button is fastened to the rotation limiter and oppositely exposed through an opening on a down side of the support base to allow a user to slidably move the rotation limiter from the first position to the second position.

13. The foldable pedestal of claim 10, wherein the blocking extension is shaped in a manner to sidewise lie adjacent to a side of the rotation limiter in the second position when the LCD panel is in the folding position so that the rotation limiter is prevented from coming back to the first position, thereby allowing a reverse rotation of the rotary plate to unfold the LCD panel.

14. The foldable pedestal of claim 10, wherein the blocking extension is arranged in a U-like shape.

15. The foldable pedestal of claim 10, wherein the blocking extension is arranged in a F-like shape.

16. The foldable pedestal of claim 10, wherein the support base further includes a casing having a contour shaped in a handle enabling a user to carry the foldable pedestal by gripping the handle once the foldable pedestal is folded.
